(19) United States
(12) Patent Application Publication
(10) Pub. No.: US 2012/0022912 A1
(43) Pub. Date: Jan. 26, 2012

(54) METHOD AND APPARATUS FOR SUPERVISING INTEGRATED TRIP MARGIN OF FACILITIES IN INDUSTRIAL PLANT

(75) Inventor: Kitae Kim, Daejeon (KR)

(73) Assignee: BNF Technology Inc., Daejeon (KR)

(21) Appl. No.: 12/674,781

(22) PCT Filed: Aug. 28, 2008
(86) PCT No.: PCT/KR08/05037

§ 371 Date: Feb. 23, 2010

(30) Foreign Application Priority Data
Aug. 28, 2007 (KR) 10-2007-0086430

(51) Int. Cl. G06Q 10/00

(52) U.S. Cl. 705/7.28

(57) ABSTRACT

Disclosed is a method and an apparatus for supervising the integrated trip margin of an industrial plant facility. The apparatus includes a measurement operation value collection means for collecting a measurement operation value of a facility having a trip setting value inside the industrial plant; a trip margin calculation means for receiving the measurement operation value from the measurement operation value collection means and calculating a trip margin; and a display means for displaying a trip margin having a smallest value among trip margins of respective groups on a screen when there is a plurality of groups of objects of interest, the trip margin of which is to be supervised. When supervising the trip margin of a facility within a plant, which has a trip setting value, information regarding a trip-related signal having the highest possibility of trip occurrence and the movement of the overall trip-related signals are grouped and displayed on the screen so that relevant people can supervise them more easily. As a result, any abnormal condition of facilities is detected as early as possible. This decreases the occurrence of trip, and increases the operating rate of the plant.

### TECHNICAL FIELD

The present invention relates to a method and an apparatus for supervising the integrated trip margin of an industrial plant facility. More particularly, the present invention relates to a method and a system for supervising the integrated trip margin of an industrial plant facility, wherein the method for supervising a plant facility having a trip setting value is improved by calculating the trip margin of all trip-related signals and providing concerned people with a signal having the highest possibility of trip occurrence among the signals and the movement of the entire signals in an integrated manner.

### BACKGROUND ART

In general, various industrial plants have a lot of facilities, the operation of which is supervised to take necessary measures before a serious problem occurs.

There are usually a very large number of measuring devices inside an industrial plant to measure the operating condition of facilities, and supervisors check and supervise the measurement results of individual measurement devices by the naked eye. This way of checking numerous measuring devices by the naked eye requires a high level of concentration.

Particularly, continuous supervision of a large number of devices results in accumulated fatigue, and the resulting stress degrades the level of concentration of supervisors. This increases the possibility that the supervisors will fail to correctly recognize data on the measuring devices.

As such, it is substantially difficult for supervisors to monitor a large number of measuring devices and check whether or not facilities are operating normally. Particularly, it is less likely to monitor the corresponding measuring device at the right time and confirm if the facility is functioning normally before the facility beings to malfunction. In most cases, it is not until the alarm rings that the operator recognizes the abnormal condition of the facility and takes necessary measures.

In summary, any abnormal condition of a facility is not detected in advance, but only after a problem has occurred or after a problem is imminent. This makes it more difficult to deal with the problem. As a result, the possibility of trip (shutdown) of the facility increases. In other words, the operating rate of the facility degrades.

### DISCLOSURE OF INVENTION

### Technical Solution

Therefore, the present invention has been made in view of the above-mentioned problems, and the present invention provides a method and an apparatus for calculating and supervising the trip margin and the trip margin time of a facility inside a plant, which has a trip setting value, so that signals having a higher possibility of trip occurrence and the movement of the entire signals are integrated and supervised on a single screen.

In accordance with an aspect of the present invention, there is provided an apparatus for supervising an integrated trip margin of an industrial plant facility, the apparatus including a measurement operation value collection means for collecting a measurement operation value of a facility having a trip setting value inside the industrial plant; a trip margin calculation means for receiving the measurement operation value from the measurement operation value collection means and calculating a trip margin; and a display means for displaying a trip margin having a smallest value among trip margins of respective groups on a screen when there is a plurality of groups of objects of interest, the trip margin of which is to be supervised.

In accordance with another aspect of the present invention, there is provided an apparatus for supervising an integrated trip margin of an industrial plant facility, the apparatus including a measurement operation value collection means for collecting a measurement operation value of a facility having a trip setting value inside the industrial plant; a trip margin calculation means for receiving the measurement operation value from the measurement operation value collection means and calculating a trip margin; and a display means for displaying a predetermined number of lowest trip margins among trip margins within an object of interest, the trip margin of which is to be supervised, on a screen.

In accordance with another aspect of the present invention, there is provided a method for supervising an integrated trip margin of an industrial plant facility by an integrated trip margin supervising apparatus having a measurement operation value collection means, a trip margin calculation means, and a display means, the method including the steps of collecting a measurement operation value of a facility having a trip setting value inside the industrial plant by the measurement operation value collection means; calculating a trip margin from the measurement operation value and storing the trip margin by the trip margin calculation means; and displaying a predetermined number of lowest trip margins among trip margins within an object of interest on a screen on the display means when there is one object of interest, the trip margin of which is to be supervised, or displaying each trip margin having a smallest value among trip margins within each group on a screen when there is a plurality of groups of objects of interest.

According to the present invention, the trip margin of a facility in a plant, which has a trip setting value, is supervised in the following manner: information regarding a trip-related signal having the highest possibility of trip occurrence and the movement of the entire trip-related signals are grouped and displayed on the screen so that related people can supervise them more easily. As a result, operators can supervise abnormal conditions of related facilities easily and detect any problem of a facility as early as possible. This reduces the occurrence of trip and increases the operating rate of the plant.

### BRIEF DESCRIPTION OF THE DRAWINGS

FIG. 1 shows the construction of an apparatus for supervising the integrated trip margin of an industrial plant facility according to first and second embodiments of the present invention;

FIG. 2 shows a tree structure obtained by grouping facilities of a nuclear power plant in connection with the apparatus for supervising the integrated trip margin of an industrial plant facility according to the first embodiment of the present invention;

FIG. 3 shows a screen for supervising the trip margin of a nuclear power plant displayed on a display means 106 in connection with the apparatus for supervising the integrated trip margin of an industrial plant facility according to the first embodiment of the present invention;

FIG. 4 shows a screen for supervising the trip margin of a turbine displayed on a display means in connection with an apparatus for supervising the integrated trip margin of an industrial plant facility according to a preferred embodiment of the present invention;

FIG. 5 shows a screen for supervising the trip margin of a nuclear power plant displayed on a display means in connection with an apparatus for supervising the integrated trip margin of an industrial plant facility according to the second embodiment of the present invention; and

FIG. 6 is a flowchart showing a method for supervising the integrated trip margin of an industrial plant facility according to the first embodiment of the present invention.

### MODE FOR THE INVENTION

Hereinafter, exemplary embodiments of the present invention will be described with reference to the accompanying drawings. In the following description and drawings, the same reference numerals are used to designate the same or similar components, and so repetition of the description on the same or similar components will be omitted. Furthermore, a detailed description of known functions and configurations incorporated herein is omitted to avoid making the subject matter of the present invention unclear.

FIG. 1 shows the construction of an apparatus for supervising the integrated trip margin of an industrial plant facility according to first and second embodiments of the present invention.

The apparatus for supervising the integrated trip margin of an industrial plant facility according to the first embodiment of the present invention includes a measurement operation value collection means 102 for collecting the measurement operation value of a facility having a trip setting value inside the industrial plant, a trip margin calculation means 104 for receiving the measurement operation value from the measurement operation value collection means and calculating the trip margin, and a display means 108 for displaying a trip margin having the smallest value among trip margins of each group on a single screen, when there are plural groups of objects of interest, the trip margin of which is to be supervised.

The measurement operation value collection means 102 shown in FIG. 1 detects the measurement operation value of facilities having trip setting values inside the industrial plant. Among measurement operation values detected by one of detection methods, digital data may be directly transmitted to the trip margin calculation means 104. Among the detected measurement operation values, analog data may be converted by an AD converter and transmitted to the trip margin calculation means 104.

The trip margin calculation means 104 calculates the trip margin from the detected measurement operation value.

As used herein, the trip margin refers to at least one of the trip margin ratio of a trip-related signal and the trip margin time.

The trip margin ratio refers to a margin ratio of the measurement operation value of trip-related signal to the trip setting value. The normal operation point, at which the facility has a normal operation value, is defined as 100, and the trip occurrence point, at which facility trip occurs, is defined as 0. Based on this definition, the degree of closeness of the measurement operation value to the trip occurring point from the normal operation point is given as a percentage.

It will be assumed for example that a level controller of a S/G is controlled in the range of 0-10 m, the normal operation value is 5 m, and the trip setting value is 8 m. Then, the difference between 8 m and 5 m (i.e. 3 m) becomes the trip margin section, and this change area of 3 m is converted into a percentage between 0-100%.

The trip margin ratio is calculated by equation (trip margin ratio=|1−(measurement operation value normal operation value)/(trip setting value−normal operation value)|*100). If the measurement operation value of the S/G level controller is 5 m, the trip margin ratio is calculated as 100%. If the measurement operation value is 6 m, the trip margin ratio is calculated as |1−(6−5)/(8−5)|*100=67%.

The trip margin time refers to an estimated time when the measurement operation value is supposed to reach the trip setting value, and can be calculated by using the velocity of change of the measurement operation value, the acceleration, etc.

According to a method for calculating the trip margin time by using the velocity of change of the measurement operation value, the velocity of change of the measurement operation value is calculated, and the time is obtained from equation [time=|measurement operation value trip setting value|/velocity].

According to a method for calculating the velocity, the rate of change of the measurement operation value is obtained at a regular time interval, and a predetermined number of last rates of change of the measurement operation value are averaged to obtain a moving average value.

For example, the rate of change of the measurement operation value is calculated every second, and the last five calculation values are averaged to obtain the moving average as the velocity.

It will be assumed for example that the normal operation value of the level controller of the S/G is 5 m, and the trip setting value is 8 m. Furthermore, the measurement operation value is currently 6 m, and the rate of change of the measurement operation value at each second during the last five seconds is 0.1 m/s, 0.2 m/s, 0.3 m/s, 0.2 m/s, and 0.1 m/s, respectively. Then, the moving average of the five rates of change, i.e. velocity, is 0.2 m/s. Therefore, the trip margin section is 2 m.

The velocity of change of the measurement operation value is applied to equation [time=|measurement operation value trip setting value|/velocity], and the resulting time is used to obtain the trip margin time as follows: |8 m−6 m|/0.2 m/s=10 s.

Besides the velocity of change of the measurement operation value, it is also possible to calculate the acceleration and obtain the trip margin time from equation [time=(−velocity+(velocity²−4*(acceleration/2)*(−trip margin section))^{1/2})/acceleration].

More particularly, it is assumed that v, a, and c are the velocity, acceleration, and trip margin section, respectively, and the law of acceleration is applied. Then, formula (a/2*t²+v*t=c) gives a second-order equation (a/2*t²+v*t−c=0). Using the root formula, t=(−v±(v²−4*a/2*(−c))^{1/2})/(2*a/2), and the time is obtained. In this case, the time is a positive number, and formula t=(−v+(v²−4*a/2*(−c))^{1/2})/(2*a/2) is used.

It will be assumed for example that the normal operation value of the level controller of the S/G is 5 m, and the trip setting value is 8 m. In addition, the measurement operation value is currently 6 m, and, for the last two seconds, the measurement operation value has changed as much as 0.1 m/s and 0.2 m/s at each second. Then, the acceleration is 0.1 m/s². According to the present embodiment, the acceleration is obtained by calculating the rate of change of the velocity of change of the measurement operation value for two seconds.

Therefore, the root formula of second-order equations is used to obtain the time at which the trip setting value is reached from the above second-order equation (a/2*t²+v*t−c=0), to which the law of acceleration has been applied.

By using formula t=(−v+(v²−4*a/2*(−c))^{1/2})/(2*a/2), equation (0.1/2*t²+0.2* t−2=0) gives (t=(−0.2+(0.2²−4*0.1/2*(−2))^{1/2})/(2*0.1/2)), and t=4.6 s (wherein, a is acceleration, v is velocity, and c is trip margin section).

This means that trip is likely to occur after the trip margin time of 4.6 seconds.

When there is a plurality of groups of objects of interest, the trip margin of which is to be supervised, the display means 106 of the trip margin supervising apparatus according to the first embodiment displays a trip margin having the smallest value among trip margins within each group on a single screen. The object of interest may be a plurality of predetermined groups. According to an alternative method, the apparatus further includes a selection means 108 for selecting the object of interest and transmitting it to the display means so that the supervising screen can switch.

When the apparatus additionally includes a selection means 108, and when the selection means 108 selects a single group as the object of interest, a predetermined number of lowest trip margins among trip margins of the selected group may be displayed on a single screen by an additional function.

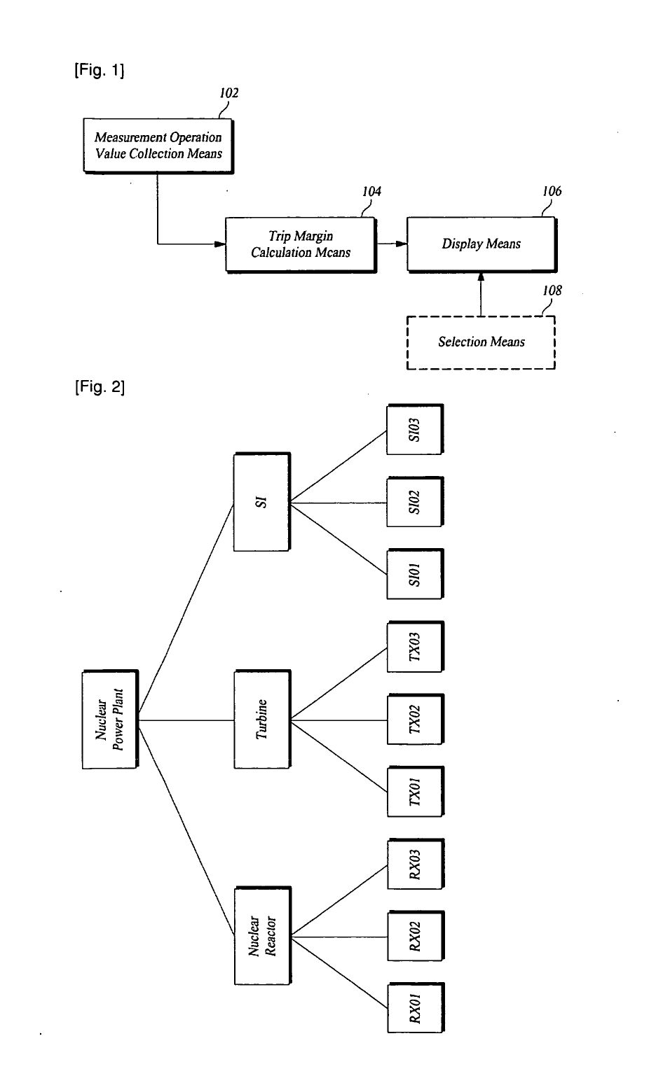

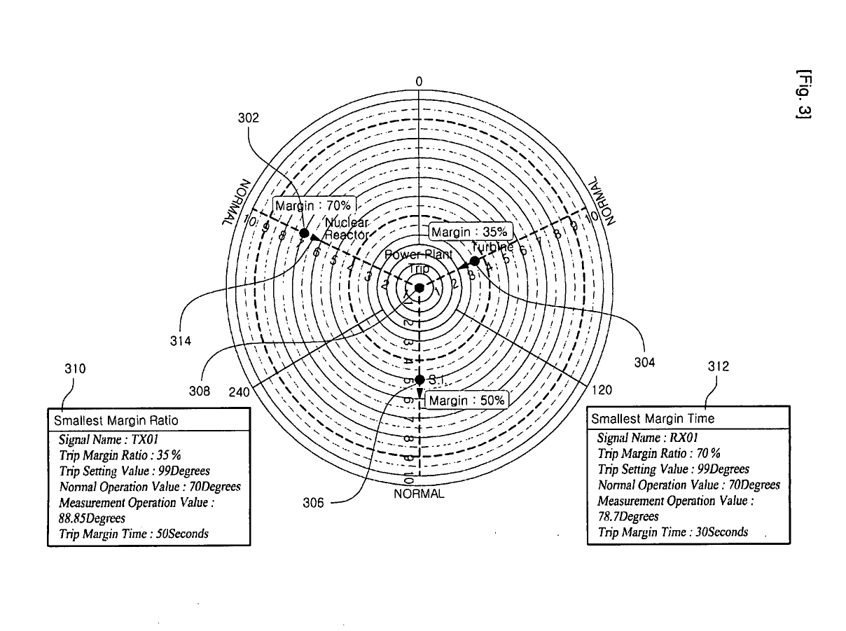

FIG. 2 shows a tree structure obtained by grouping facilities of a nuclear power plant in connection with the apparatus for supervising the integrated trip margin of an industrial plant facility according to the first embodiment of the present invention.

As shown in FIG. 2, facilities of the nuclear power plant are classified into three large groups: nuclear reactor, turbine, and SI groups. Signals related to trip of the nuclear reactor are classified into small groups: RX01, RX02, and RX03 groups. Signals related to trip of the turbine are classified into small groups: TX01, TX02, and TX03 groups. Signals related to trip of the SI are classified into small groups: SI01, SI02, and SI03 groups. Such classification into large and small groups gives the tree structure shown in FIG. 2.

If the nuclear reactor, turbine, and SI have been designated as the object of interest, the smallest trip margin in the nuclear reactor, the smallest trip margin in the turbine, and the smallest trip margin in the SI can be displayed, respectively.

When a group has been selected as the object of interest by the selection means 108, a predetermined number of lowest trip margins among trip margins within the selected group may be displayed on a single screen by an additional function. Particularly, if the selection means 108 selects the nuclear reactor as the object of interest, and if the predetermined number is three, the trip margin of RX01, RX02, and RX03 are displayed.

As mentioned above, the object of interest is either designated in advance or selected by the selection means 108. Unless otherwise mentioned, it will be assumed in the following description that the object of interest is selected by the selection means 108.

In the case of a nuclear power plant shown in FIG. 2, the entire facilities are classified into nuclear reactor, turbine, and SI groups, for example, and the selection means 108 selects the nuclear reactor, the turbine, and the SI as the object of interest so that, among trip margin ratios of each group, a trip margin ratio having the smallest value can be displayed.

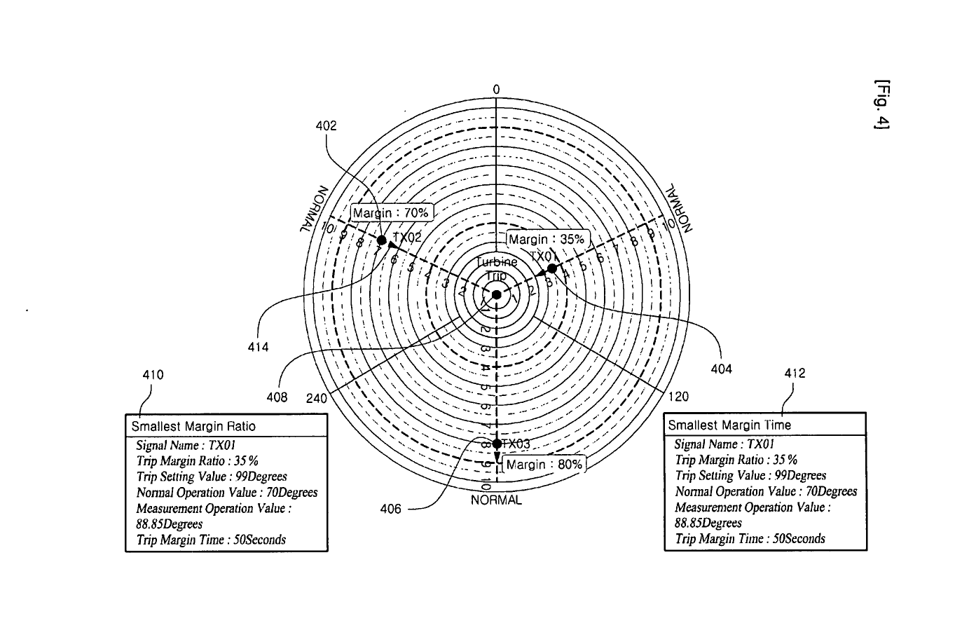

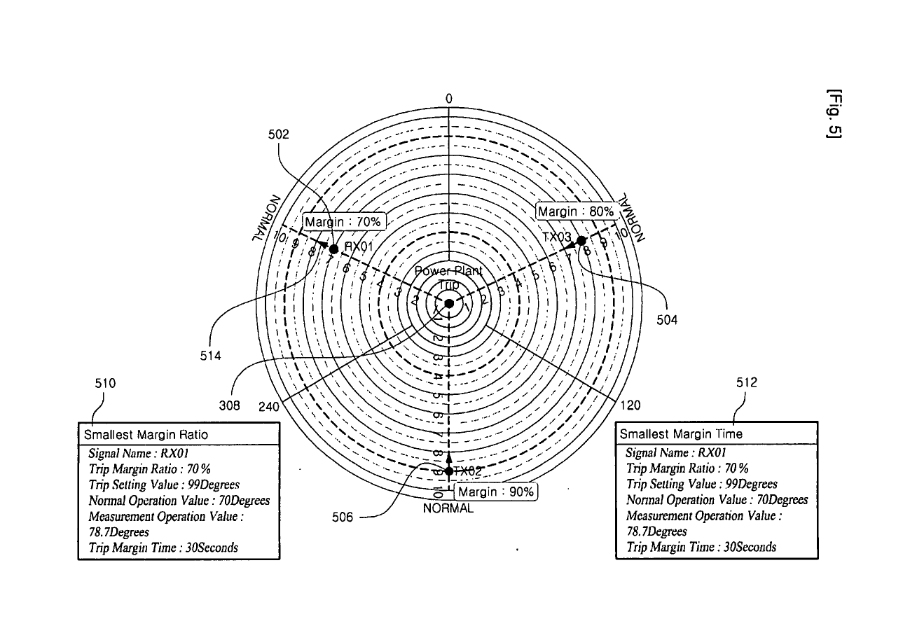

In this manner, the trip margin of interest of facilities of each group of the nuclear power plant can be supervised, as will be described later in more detail with reference to FIG. 3. When the turbine is selected as the group to be displayed, it is possible to choose to display the trip margin of interest of a predetermined number of facilities having the smallest value among trip margins of a plurality of trip-related signals of the turbine, as will be described later in more detail with reference to FIG. 4.

The case of the nuclear power plant, facilities of which to be supervised are grouped and assigned according to the tree structure shown in FIG. 2, as mentioned above, will now be described as an example.

The facilities of the nuclear power plant are classified into three large groups: nuclear reactor, turbine, and SI groups, and three signals are assigned to each group. The groups may also be subdivided if there are more signals.
Nuclear reactor: RX01, RX02, and RX03
Turbine: TX01, TX02, and TX03
SI: SI01, SI02, and SI03

It will be assumed that the trip margin ratio and the trip margin time of respective signals are calculated in the following manner:
RX01: trip margin ratio=70%, trip margin time=30 seconds
RX02: trip margin ratio=80%, trip margin time=40 seconds
RX03: trip margin ratio=90%, trip margin time=40 seconds
TX01: trip margin ratio=35%, trip margin time=50 seconds
TX02: trip margin ratio=70%, trip margin time=60 seconds
TX03: trip margin ratio=80%, trip margin time=60 seconds
SI01: trip margin ratio=50%, trip margin time=100 minutes
SI02: trip margin ratio=90%, trip margin time=90 seconds
SI03: trip margin ratio=100%, trip margin time=95 seconds

Among the entire signals, the smallest trip margin ratio signal and the smallest trip margin time signal are as follows:
Smallest trip margin ratio: TX01, trip margin=35%
Smallest trip margin time: RX01, trip margin time=30 seconds

And the smallest trip margin ratio of each group is as follows:
Nuclear reactor: RX01, trip margin ratio=70%
Turbine: TX01, trip margin ratio=35%
SI: SI01, trip margin ratio=50%

Based on the above materials, the display screen according to the first embodiment is constructed as shown in FIGS. 3 and 4.

FIG. 3 shows a screen for supervising the trip margin of a nuclear power plant displayed on a display means 106 in connection with the apparatus for supervising the integrated trip margin of an industrial plant facility according to the first embodiment of the present invention. The trip margin displayed in FIG. 3 is the trip margin ratio.

According to the embodiment shown in FIG. 3, facilities of a nuclear power plant are classified into three large groups: nuclear reactor, turbine, and S/I groups, and the trip margin ratio of interest of trip-related signals having the smallest trip margin ratio within each group is displayed.

As shown in FIG. 3, the display means 106 displays the smallest trip margin ratio 302 of the nuclear reactor, the smallest trip margin ratio 304 of the turbine, the smallest trip margin ratio 306 of the SI, and the power plant trip point 308. The display means 106 may additionally display operation data 310 regarding a facility having the smallest trip margin ratio of the power plant among the entire selected groups, and operation data 312 regarding a facility having the smallest trip margin time of the power plant.

In FIG. 3, points indicating measurement operation values having the smallest trip margin ratios 302, 304, and 306 for respective facility groups are positioned at the center of the circle when power plant trip has occurred, i.e. when the trip margin ratio is 0. In the case of a normal operation value, the point is positioned at the outermost portion of the circle. In other words, the closer to trip, the more the point approaches the center from the outer portion. A display function may be added so that, if a measurement operation value changes in a direction facing the trip point, an arrow 314 faces the trip point, and if the measurement operation value changes in a direction facing away from the trip point, the arrow faces away from the trip point.

The length of an arrow may be varied depending on the velocity or acceleration. Particularly, the longer an arrow is, the larger the rate of change of the measurement operation value is.

Besides the above-mentioned display method of positioning the trip point at the center of the circle, it is also possible to use a vertical bar graph, a horizontal bar graph, etc.

In the example shown in FIG. 3, the smallest trip margin ratio 302 of the nuclear reactor among facilities within the nuclear power plant is 70%, the smallest trip margin ratio 304 of the turbine is 35%, and the smallest trip margin ratio 306 of the SI is 50%.

The trip margin display means 108 may additionally display operation data 310 regarding a facility having the smallest trip margin ratio among trip-related signals displaying a group selected by the selection means, as well as operation data 312 regarding a facility having the smallest trip margin time.

As shown in FIG. 3, a facility having the smallest trip margin ratio corresponds to the TX01 signal of the turbine. Particularly, the trip margin ratio is 35%, the trip setting value is 99 degrees, the normal operation value is 70 degrees, the current value is 88.8 degrees, and the trip margin time is 50 seconds.

In addition, a facility having the smallest trip margin time corresponds to the RX01 signal of the nuclear reactor. Particularly, the trip margin ratio is 70%, the trip setting value is 99 degrees, the normal operation value is 70 degrees, the current value is 78.8 degrees, and the trip margin time is 30 seconds.

FIG. 4 shows a screen for supervising the trip margin of a turbine displayed on a display means in connection with the apparatus for supervising the integrated trip margin of an industrial plant facility according to a preferred embodiment of the present invention.

The screen shown in FIG. 4 is displayed when the turbine on the screen shown in FIG. 3 is selected by the selection means 108. As shown in FIG. 4, the display means 106 may display the TX02 trip margin ratio 402 of the turbine, the TX01 trip margin ratio 404, the TX03 trip margin ratio 406, the turbine trip point 408, the operation data 410 regarding a facility having the smallest margin ratio of the turbine, and operation data 412 regarding a facility having the smallest margin time of the turbine.

In FIG. 4, points indicating measurement operation values having the smallest trip margin ratios 402, 404, and 406 for respective facilities are positioned at the center of the circle when turbine trip has occurred, i.e. when the trip margin ratio is 0. In the case of a normal operation value, the point is positioned at the outermost portion of the circle. In other words, the closer to trip, the more the point approaches the center from the outer portion. A display function may be added so that, if a measurement operation value changes in a direction facing the trip point, an arrow 414 faces the trip point, and if the measurement operation value changes in a direction facing away from the trip point, the arrow faces away from the trip point.

The length of an arrow may be varied depending on the velocity or acceleration. Particularly, the longer an arrow is, the larger the rate of change of the measurement operation value is.

Various screen display methods may be used as follows: normal operation values are positioned at the center of the circle, and trip setting values are positioned on the outer side of the circle. Alternatively, a vertical or horizontal bar graph may be used.

In the example shown in FIG. 4, the smallest trip margin ratio 402 of the TX02 signal in the turbine within the nuclear power plant is 70%, the smallest trip margin ratio 404 of the TX01 signal is 35%, and the smallest trip margin ratio 406 of the TX03 signal is 80%.

The trip margin display means 108 may additionally display operation data 410 regarding a facility having the smallest trip margin ratio among all trip-related signals, as well as operation data 412 regarding facility having the smallest trip margin time.

As shown in FIG. 4, a trip-related signal of the turbine having the smallest trip margin ratio is TX01 signal. Particularly, the trip margin is 35%, the trip setting value is 99 degrees, the normal operation value is 70 degrees, the current value is 88.8 degrees, and the trip margin time is 50 seconds.

In addition, a trip-related signal of the turbine having the smallest trip margin ratio is the TX01 signal. Particularly, the trip margin is 35%, the trip setting value is 99 degrees, the normal operation value is 70 degrees, the current value is 88.8 degrees, and the trip margin time is 50 seconds.

As shown in FIG. 1, an apparatus for supervising the integrated trip margin of an industrial plant facility according to a second embodiment of the present invention includes a measurement operation value collection means 102 for collecting the measurement operation value of a facility having a trip setting value inside the industrial plant, a trip margin calculation means 104 for receiving the measurement operating value from the measurement operation value collection means and calculating the trip margin, and a trip margin display means 108 for displaying a predetermined number of lowest trip margins among trip margins within an object of interest, the trip margin of which is to be supervised, on a single screen.

In FIG. 1, the measurement operation value collection means 102 detects the measurement operation value of facilities having trip setting values inside the industrial plant. Among measurement operation values detected by one of detection methods, digital data may be directly transmitted to the trip margin calculation means 104. Among the detected measurement operation values, analog data may be converted by an AD converter and transmitted to the trip margin calculation means 104.

The trip margin calculation means 104 calculates the trip margin from the detected measurement operation value.

As used herein, the trip margin refers to at least one of the trip margin ratio of a trip-related signal and the trip margin time.

The trip margin ratio refers to a margin ratio of the measurement operation value of a trip-related signal to the trip setting value. The normal operation point, at which the facility has a normal operation value, is defined as 100, and the trip occurrence point, at which facility trip occurs, is defined as 0. Based on this, the degree of closeness of the measurement operation value to the trip occurrence point from the normal operation point is given as a percentage.

The trip margin time refers to an estimated time when the measurement operation value is supposed to reach the trip setting value, and can be calculated by using the velocity of change of the measurement operation value, the acceleration, etc.

The method for calculating the trip margin ratio and the trip margin time, as well as velocity and acceleration necessary to calculate them, may be the same as described with reference to the apparatus for supervising the integrated trip margin of an industrial plant facility according to the first embodiment.

A display method using the display means will now be described.

It will be assumed that trip-related signals of the entire facilities having trip setting values are as follows:
Nuclear reactor: RX01, RX02, and RX03
Turbine: TX01, TX02, and TX03

It will be assumed that the trip margin ratio and the trip margin time of respective signals are calculated in the following manner:
RX01: trip margin ratio=70%, trip margin time=30 seconds
RX02: trip margin ratio=95%, trip margin time=40 seconds
RX03: trip margin ratio=100%, trip margin time=40 seconds
TX01: trip margin ratio=95%, trip margin time=50 seconds
TX02: trip margin ratio=90%, trip margin time=60 seconds
TX03: trip margin ratio=80%, trip margin time=60 seconds

Furthermore, it will be assumed in connection with display of a predetermined number of lowest trip margins that the predetermined number is three, and the displayed trip margin is the trip margin ratio.

Based on the assumption that the predetermined number is three, the predetermined number of lowest trip margins are: (RX01: 70%), (TX02: 90%), and (TX03: 80%).

FIG. 5 shows a screen for supervising the trip margin of a nuclear power plant displayed on a display means in connection with the apparatus for supervising the integrated trip margin of an industrial plant facility according to the second embodiment of the present invention.

As shown in FIG. 5, the display means can display the RX01 trip margin ratio 502, the TX03 trip margin ratio 504, the TX02 trip margin ratio 506, the power plant trip point 508, operation data 510 regarding a facility having the smallest trip margin ratio of the power plant, and operation data 512 regarding a facility having the smallest trip margin time of the power plant.

In FIG. 5, points indicating measurement operation values having a predetermined number of lowest trip margin ratios 502, 504, and 506 are positioned at the center of the circle when power plant trip has occurred, i.e. when the trip margin ratio is 0. In the case of a normal operation value, the point is positioned at the outermost portion of the circle. In other words, the closer to trip, the more the point approaches the center from the outer portion. A display function may be added so that, if a measurement operation value changes in a direction facing the trip point, an arrow 514 faces the trip point, and if the measurement operation value changes in a direction facing away from the trip point, the arrow faces away from the trip point.

The length of an arrow may be varied depending on the velocity or acceleration. Particularly, the longer an arrow is, the larger the rate of change of the measurement operation value is.

Various screen display methods may be used as follows: normal operation values are positioned at the center of the circle, and trip setting values are positioned on the outer side of the circle. Alternatively, a vertical or horizontal bar graph may be used.

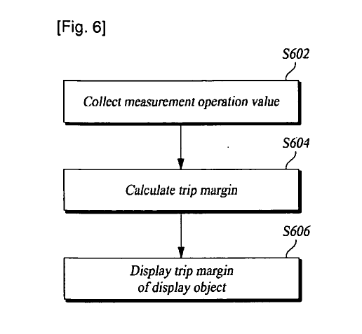

FIG. 6 is a flowchart showing a method for supervising the integrated trip margin of an industrial plant facility according to the first embodiment of the present invention.

As shown in FIG. 6, the method for supervising the integrated trip margin of an industrial plant facility by the integrated trip margin supervising apparatus, which has a measurement operation value collection means, a trip margin calculation means, and a display means, includes the steps of collecting measurement the measurement operation value of a facility having a trip setting value inside the industrial plant by the measurement operation collection means (S602), calculating the trip margin from the measurement operation value and storing the trip margin by the trip margin calculation means (S604), displaying a predetermined number of lowest trip margins among trip margins within an object of interest on a single screen on the display when there is only one object of interest, the trip margin of which is to be supervised, or displaying each trip margin having the smallest value among trip margins of respective groups on a single screen when there are plural groups of objects of interest (S606).

As used herein, the trip margin refers to at least one of the trip margin ratio of a trip-related signal and the trip margin time.

The method for calculating the trip margin ratio and the trip margin time, as well as velocity and acceleration necessary to calculate them, may be the same as described with reference to the apparatus for supervising the integrated trip margin of an industrial plant facility according to the first embodiment.

Although exemplary embodiments of the present invention have been described for illustrative purposes, those skilled in the art will appreciate that various modifications, additions and substitutions are possible, without departing from the scope and spirit of the invention as disclosed in the accompanying claims. Therefore, the disclosed embodiments of the present invention are not for limiting the technical idea of the invention, but for describing it, and do not limit the scope of the present invention in any manner. The scope of the present invention is to be interpreted by the accompanying claims, and any technical idea in the equivalent range is to be regarded as included in the scope of the present invention.

### INDUSTRIAL APPLICABILITY

The present invention is advantageous in that, when supervising the trip margin of a facility within a plant, which has a trip setting value, information regarding a trip-related signal having the highest possibility of trip occurrence and the movement of the overall trip-related signals are grouped and displayed on the screen so that relevant people can supervise them more easily. As a result, any abnormal condition of facilities is detected as early as possible. This decreases the occurrence of trip, and increases the operating rate of the plant.

1. An apparatus for supervising an integrated trip margin of an industrial plant facility, the apparatus comprising:
a measurement operation value collection means for collecting a measurement operation value of a facility having a trip setting value inside the industrial plant;
a trip margin calculation means for receiving the measurement operation value from the measurement operation value collection means and calculating a trip margin; and
a display means for displaying a trip margin having a smallest value among trip margins of respective groups on a screen when there is a plurality of groups of objects of interest, the trip margin of which is to be supervised.

2. The apparatus as claimed in claim 1, further comprising a selection means for receiving an input regarding the object of interest and transmitting the object of interest to the display means.

3. The apparatus as claimed in claim 2, wherein the object of interest is selected by the selection means.

4. The apparatus as claimed in claim 2, wherein the display means has an additional function of displaying a predetermined number of lowest trip margins among trip margins within a group on a screen when the group has been selected as the object of interest by the selection means.

5. The apparatus as claimed in claim 1, wherein the display means is adapted to additionally display a direction of change of the trip margin.

6. The apparatus as claimed in claim 1, wherein the trip margin is at least one of a trip margin ratio and a trip margin time.

7. The apparatus as claimed in claim 6, wherein the trip margin ratio is a margin ratio of the measurement operation value to the trip setting value obtained by defining a normal operation point and a trip occurring point of the facility as 100 and 0, respectively, and expressing a degree of closeness of the measurement operation value to the trip occurring point from the normal operation point as a percentage.

8. The apparatus as claimed in claim 6, wherein the trip margin time is an estimated time when the measurement operation time is supposed to reach the trip setting value.

9. The apparatus as claimed in claim 8, wherein the estimated time is obtained by calculating velocity of change of the measurement operation value and applying equation [time=|measurement operation value−trip setting value|/velocity].

10. The apparatus as claimed in claim 9, wherein the velocity is a moving average value calculated by obtaining a rate of change of the measurement operation value at a regular time interval and averaging a predetermined number of last rates of change of the measurement operation value.

11. The apparatus as claimed in claim 8, wherein the estimated time is obtained by calculating velocity of change of the measurement operation value and acceleration and applying equation [time=(−velocity+velocity²−4*(acceleration/2)*(−trip margin section))^{1/2})/acceleration].

12. An apparatus for supervising an integrated trip margin of an industrial plant facility, the apparatus comprising:
a measurement operation value collection means for collecting a measurement operation value of a facility having a trip setting value inside the industrial plant;
a trip margin calculation means for receiving the measurement operation value from the measurement operation value collection means and calculating a trip margin; and
a display means for displaying a predetermined number of lowest trip margins among trip margins within an object of interest, the trip margin of which is to be supervised, on a screen.

13. The apparatus as claimed in claim 12, further comprising a selection means for receiving an input regarding the object of interest and transmitting the object of interest to the display means.

14. The apparatus as claimed in claim 12, wherein the object of interest is the industrial plant.

15. The apparatus as claimed in claim 12, wherein the object of interest is a facility selected by the selection means.

16. The apparatus as claimed in claim 12, wherein the display means is adapted to additionally display a direction of change of the trip margin.

17. The apparatus as claimed in claim 12, wherein the trip margin is at least one of a trip margin ratio and a trip margin time.

18. The apparatus as claimed in claim 17, wherein the trip margin ratio is a margin ratio of the measurement operation value to the trip setting value obtained by defining a normal operation point and a trip occurring point of the facility as 100 and 0, respectively, and expressing a degree of closeness of the measurement operation value to the trip occurring point from the normal operation point as a percentage.

19. The apparatus as claimed in claim 17, wherein the trip margin time is an estimated time when the measurement operation time is supposed to reach the trip setting value.

20. The apparatus as claimed in claim 19, wherein the estimated time is obtained by calculating velocity of change of the measurement operation value and applying equation [time=|measurement operation value−trip setting value|/velocity].

21. The apparatus as claimed in claim 20, wherein the velocity is a moving average value calculated by obtaining a rate of change of the measurement operation value at a regular time interval and averaging a predetermined number of last rates of change of the measurement operation value.

22. The apparatus as claimed in claim 19, wherein the estimated time is obtained by calculating velocity of change of the measurement operation value and acceleration and applying equation [time=(−velocity+velocity²−4* (acceleration/2)*(−trip margin section))^{1/2})/acceleration].

23. A method for supervising an integrated trip margin of an industrial plant facility by an integrated trip margin supervising apparatus having a measurement operation value collection means, a trip margin calculation means, and a display means, the method comprising the steps of:
collecting a measurement operation value of a facility having a trip setting value inside the industrial plant by the measurement operation value collection means;
calculating a trip margin from the measurement operation value and storing the trip margin by the trip margin calculation means; and
displaying a predetermined number of lowest trip margins among trip margins within an object of interest on a screen on the display means when there is one object of interest, the trip margin of which is to be supervised, or displaying each trip margin having a smallest value among trip margins within each group on a screen when there is a plurality of groups of objects of interest.

24. The method as claimed in claim 23, wherein the trip margin is at least one of a trip margin ratio and a trip margin time.

25. The method as claimed in claim 24, wherein the trip margin ratio is a margin ratio of the measurement operation value to the trip setting value obtained by defining a normal operation point and a trip occurring point of the facility as 100 and 0, respectively, and expressing a degree of closeness of the measurement operation value to the trip occurring point from the normal operation point as a percentage.

26. The method as claimed in claim 24, wherein the trip margin time is an estimated time when the measurement operation time is supposed to reach the trip setting value.

27. The method as claimed in claim 26, wherein the estimated time is obtained by calculating velocity of change of the measurement operation value and applying equation [time=|measurement operation value−trip setting value|/velocity].

28. The method as claimed in claim 26, wherein the estimated time is obtained by calculating velocity of change of the measurement operation value and acceleration and applying equation [time=(−velocity+velocity²−4* (acceleration/2)*(−trip margin section))^{1/2})/acceleration].
